(19) United States
(12) Patent Application Publication
(10) Pub. No.: US 2014/0207534 A1
(43) Pub. Date: Jul. 24, 2014

(54) Skills Amelioration System

(71) Applicant: INTERNATIONAL BUSINESS MACHINES CORPORATION, Armonk, NY (US)

(72) Inventors: Al Chakra, RTP, NC (US); John A. Feller, RTP, NC (US); Trudy Leigh Hewitt, Durham, NC (US); Francesco Carmine Schembari, Durham, NC (US)

(73) Assignee: International Business Machines Corporation, Armonk, NY (US)

(21) Appl. No.: 13/749,255

(22) Filed: Jan. 24, 2013

(51) Int. Cl. G06Q 10/06

(52) U.S. Cl. CPC G06Q 10/06398
USPC 705/7.42

(57) ABSTRACT

Required certifications and education for each member of a group are automatically scanned. Current certifications and educational requirements are compared against the current job function, skills, and location for each member of the group, such as for each employee of a department of a company. These statuses and requirements are assigned into a management and employee portal or dashboard based according to pre-defined requirements. The portal or dashboard is also populated to provide specific requirements for unmet or under-met requirements, and tracking of the progress of certifications is enabled for both managers and employees to be proactive in taking action on certifications and education.

### FIELD OF THE INVENTION

The invention generally relates to technologies for automatically assessing the skills and training for a particular job or project, and for identifying any additional training or certification which may be necessary to comply with contractual or regulatory requirements.

### BACKGROUND OF INVENTION

Many roles, jobs, positions and professions require various training and certifications beyond degrees, certificates and diplomas offered by educational institutions. Some of these training and certification requirements are one-time in nature, while others require periodic renewal and updating. Whether you are a teacher and you must complete updated certification in subject ranging from educational techniques to proper handling of infectious diseases among students, or a programmer who requires updated certification to maintain credentials for a particular software product, or an insurance agent who must complete ethics and confidential information handling training, these requirements can be driven by corporate standards, by professional group rules (bar association, medical association, etc.), or by law.

Multiple certification processes required by teams across large companies and organizations which have no standard certification process or tracking mechanism for managers to ensure compliance by their teams presents a problem, both in efficacy and efficiency. Managers may be required to manually to compile status reports, analyze budget requirements, and review pertinent corporate, contractual, professional and legal standards.

### SUMMARY OF EMPLARY EMBODIMENTS OF THE INVENTION

Required certifications and education for each member of a group are automatically scanned. Current certifications and educational requirements are compared against the current job function, skills, and location for each member of the group, such as for each employee of a department of a company. These statuses and requirements are assigned into a management and employee portal or dashboard based according to pre-defined requirements. The portal or dashboard is also populated to provide specific requirements for unmet or under-met requirements, and tracking of the progress of certifications is enabled for both managers and employees to be proactive in taking action on certifications and education.

### BRIEF DESCRIPTION OF THE DRAWINGS

The description set forth herein is illustrated by the several drawings.

FIG. 1 provides an architectural overview of at least one embodiment of the invention.

FIG. 2a illustrates an example encoding of a user profile.

FIG. 2b sets forth an example encoding of a requirements set.

FIG. 3a shows an example encoding of the results of amelioration analysis.

FIG. 3b illustrates a dashboard display.

FIG. 4 sets forth a generalized architecture of computing platforms suitable for at least one embodiment of the present and the related inventions.

### DETAILED DESCRIPTION OF EXEMPLARY EMBODIMENT(S) OF THE INVENTION

The inventors of the present and the related invention have recognized problems not yet recognized by those skilled in the relevant arts. As previously stated in this disclosure, many roles, jobs, positions and professions require various training and certifications beyond degrees, certificates and diplomas offered by educational institutions. Some of these training and certification requirements are one-time in nature, while others require periodic renewal and updating. Whether you are a teacher and you must complete updated certification in subject ranging from educational techniques to proper handling of infectious diseases among students, or a programmer who requires updated certification to maintain credentials for a particular software product, or an insurance agent who must complete ethics and confidential information handling training, these requirements can be driven by corporate standards, by professional group rules (bar association, medical association, etc.), or by law.

Multiple certification processes required by teams across large companies and organizations which have no standard certification process or tracking mechanism for managers to ensure compliance by their teams presents a problem, both in efficacy and efficiency. Managers may spend hours trying manually to compile status reports, analyze budget requirements, and review pertinent corporate, contractual, professional and legal standards.

The present inventors have recognized a number of problems not fully addressed by certification and training tracking systems. Some of these problems and limitations appear to be unrecognized in the art, including:
inability for managers to track certification progress for many requirements;
compliance failure reports are often sent to higher level management without first being sent to first or second lines of supervision for action;
first line managers need visibility to requirements and completion status up-front;
there is generally lack of control surrounding the certification process, where each team requiring certifications may have their own process in place without a consistent process to follow;
there is a drain of time and resources incurred by this problem, whereas employees and managers are required to certify on a monthly, quarterly and annual basis that they have completed a particular task; and
these certification processes can be inconsistent and incomplete, requiring follow-up actions by the manager, by the employee, or both (e.g. some tracking systems copy managers and some do not, some systems have a view to determine employee certification and some do not).

Furthermore, because these certification systems all use different processes and different tools, the cost involved to host and support each individual certification tool/process is taxing on the organizations infrastructure.

The present inventors have recognized that there is a lack of a portal or dashboard to show what is required, when it is required, and what is required of each member of an organization, and their management team, in terms of actual training, certification, calendar demands and budgetary requirements.

Here is an example of the foregoing problems taken from an actual set of events. A company, whose name shall be withheld, instituted an Intellectual Property training and certification requirements. In this example, the IP education certification process was handled through email notifications to employees, who were directed to a website that required the employee to watch a video and then to click on a link at the very end of the video to certify that they had completed the process. Problems and weaknesses of this particular training process included:
separate emails were sent out to all of the affected employees stating the requirement for this training;
however, no standard certification tool was used that allowed managers and/or employees to confirm their certification status and confirm completion; and
delinquent employees were sent a follow-up email (example below) without a copy to the employees' managers to advise that they are past due by 50 days or more.

Because the delinquency reminder message was sent 50 days after the initial deadline, and because there was no tool to view certifications status by the employee or the manager, neither was enabled to act proactively to ensure certification compliance if the first email was not seen or was buried in an to-do list.

### General Concept of Embodiments According to the Invention

Many embodiments according to the present invention will share a general concept, but not particularly all embodiments will include this general concept, which is to automatically scan required certifications and education for each member of a group, and to automatically compare those current certifications and educational requirements against the current job function, skills, and location. Then, these statuses and requirements are assigned into a management and employee portal or dashboard based on what is matched based on pre-defined requirements. The portal or dashboard is also populated to provide specific requirements for unmet or under-met requirements, and tracking of the progress of certifications is enabled for both managers and employees to be proactive in taking action on certifications and education.

The benefits of and advantages of embodiments of the invention include significant cost and resource savings, creation of a single location where all certifications leverage the same processes, considerable reduction in infrastructure (servers, network bandwidth, and support team time) demands, and provision of a single tool for managers and group members to view overdue, lapsed, current, etc., requirements to enhance compliance, and to allow longer range planning and budgeting.

Systems and methods according to the present invention identify and track certification requirements based on defined criteria of what would be required, including the attributes and properties of the certifications (prerequisites, proactive recommendations for career development, tracking certification renewal requirements, expirations, etc.). The solution also dynamically updates the requirements if the person's information changes that would exclude them from the requirements that are no longer applicable.

General Architecture.

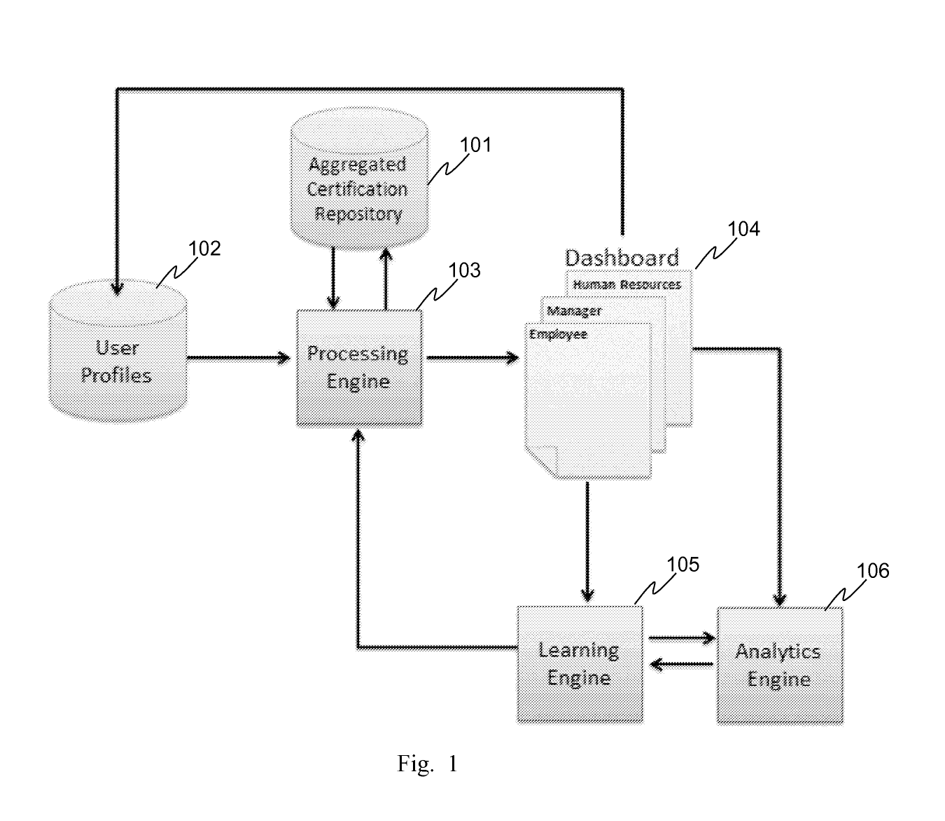

Referring to FIG. 1, the main components of an exemplary embodiment of the present invention include a processing engine (103) to coordinate the functions and activities of the other components, a aggregated certification repository (101) to hold the information regarding employees and their certifications, one or more user profiles (102) to record pertinent information for each employee and manager, a learning engine (105), an analytics engine (106), and one or more dashboard (104) style user interfaces, all of which will be described in further detail in the following paragraphs. The following example embodiments are provided for illustrative purposes, and are not intended to set the scope of the invention or to limit the range of variations of embodiments according to the invention.

Analytics Engine.

An analytics engine (106) is used to proactively scan required certifications and compare them against the User Profile (job function, skills, location, etc.) of an employee and assign into a management and employee portal or dashboard based on what is matched based on pre-defined requirements. At least one point of novelty of embodiments according to the present invention relative to the current state of the art is in having the processing engine passively monitor the users' profiles to generate the certifications that would be deemed required based on predefined criteria.

Learning Engine.

A learning engine (105) is utilized to update the processing engine, which feeds into an Aggregated Certification repository, in order to update and redefine certification programs being recommended based on the activity and/or lack of activity drawn from the analytics engine. The system will be constantly learning and updating automatically based on activity of the user and users with similar profile criteria and data.

A benefit of such embodiments is in in having an automated system to evaluate, track, and assess certifications and their status, enabling managers to see the status of across the entire team for all certifications. Creating a single location where all certifications leverage the same processes, servers and support team is anticipated to drastically decrease hardware, network and personnel costs. Furthermore, a single tool that provides managers and employees a view into overdue, current, lapsed, and upcoming certifications is anticipated to significantly increase the efficiency of managers and employees.

Such embodiments may also make comparisons regarding the time investment and program cost, and apply those against the employees' profiles to determine if the return on investment would be validated. For example, in some embodiments, the system would not provide recommendations for advanced certifications to a group member who is either below a threshold of performance, or who might not be engaged in the role for a minimum amount of future time (e.g. temporary employees, loaner employees, interns, etc.)

Exemplary User Profiles.

In this example embodiment, a User Profile definition (102) includes:
career aspirations or goals of the employee (senior individual contributor, section manager, etc.);
for current job function:
   skills and level of skills;
   band level of responsibility;
   most recent or current performance rating;
   current certifications;
   new certifications and re-certifications requirements;
   reporting structure;
and, for future or targeted job function:
   skills and level of skills;
   band level of responsibility;
   minimum performance rating to be considered for promotion;
   minimum certifications to be considered for promotion;
   certifications and re-certifications requirements; and
   reporting structure.

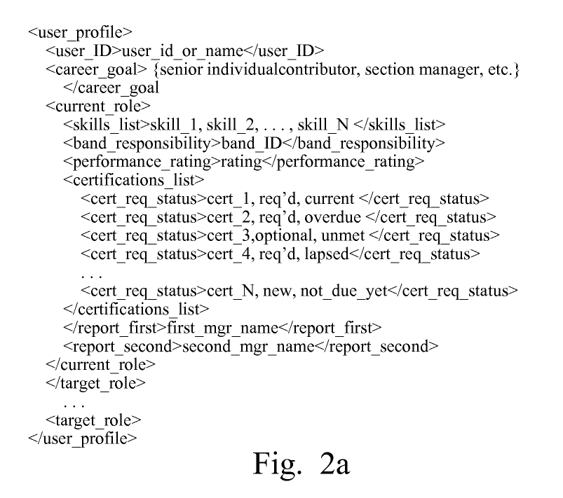

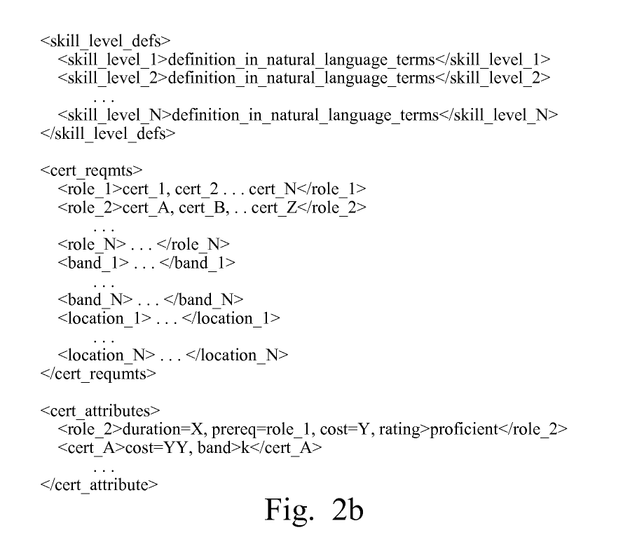

FIG. 2a illustrates a possible eXtensible Markup Language (XML) implementation of a user profile data structure.

In this example embodiment, an Aggregated Certification Repository definition includes:
detailed skill level definition(s);
certification requirements based on employee profile criteria, such as job role, band level, job location, etc.;
types and definitions of certification, such as product, project management, etc.;
attributes of certification, such as duration, skill level, prerequisites for obtaining and renewal, cost, evaluation dates, etc.;

Exemplary Aggregated Certification Repository.

FIG. 2b illustrates a possible XML implementation of such an Aggregated Requirements Repository. In at least one embodiment, a user interface is provided to view, create, and/or edit these items.

Output of Processing Engine.

The product and output of the processing engine (103) of various embodiments of the present invention may include at least two items, the first of which is a data structure populated with information, such as data records, which define a user's certification requirements, and the second of which is a user interface display or “dashboard” which the user or the user's manager may view these certification requirements.

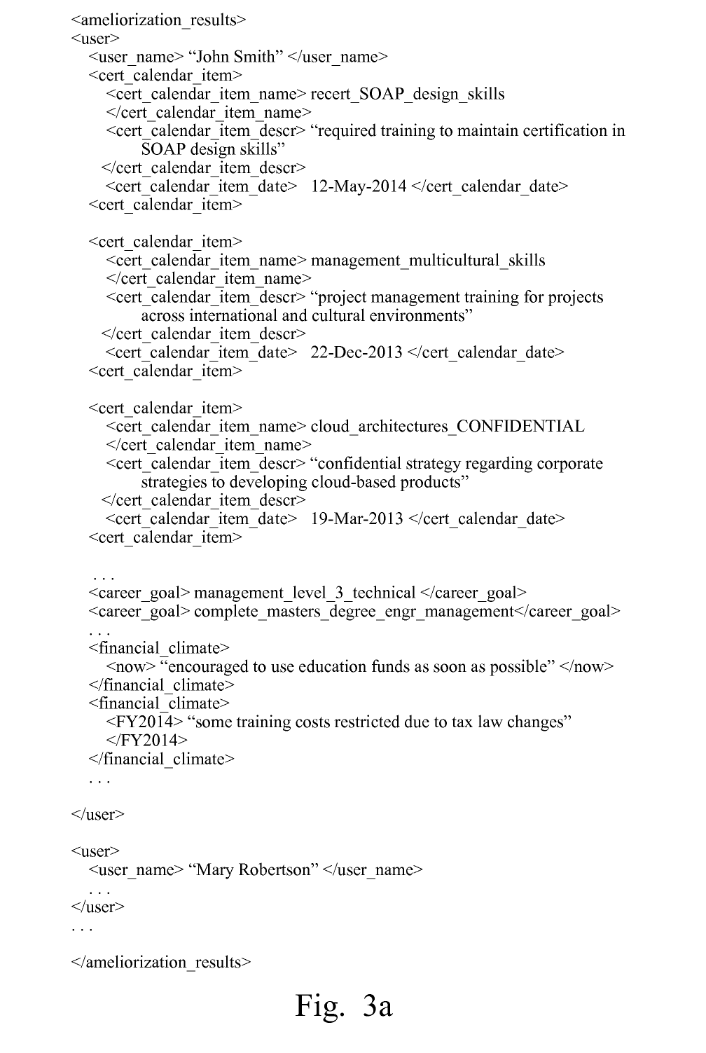

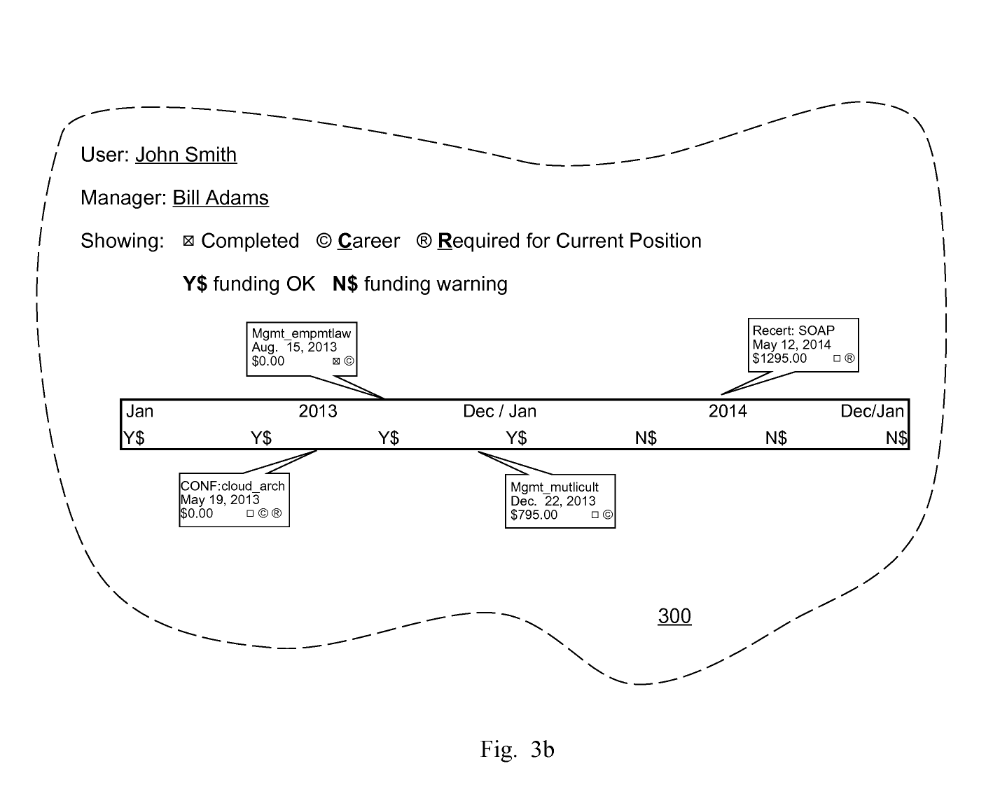

Regarding the first item of output, one embodiment includes a prioritized itemized list of requirements based on intelligence gained from different resources, such as, such as the employee's certification calendar (i.e. prioritize education that would be required for certifications that are expiring first), the employee's desired career path and aspirations, and the company's financial climate. Prioritization may take the form of weighting each item based on importance. FIG. 3a shows an example in XML of such an implementation for hypothetical employee “John Smith”.

According to at least one exemplary embodiment, the dashboard or portal user interfaces (104) provide user certification information that would enable users and their managers to make a decision based on intelligence gathered. For managers, this information may include visibility to the frequency of the certification (annual, quarterly, monthly, etc.), an explanation as to why the certification is required, detail on what is required to certify or comply (i.e. all employees must comply, or only certain employees using a certain tool must comply, etc.). Both dashboards for managers and employees may display pending actions requiring attention (due date, description of actions required, etc.), an updated status of employee(s) certifications so that managers can follow-up prior to employees being delinquent, and a timeline of when items are due so that managers can plan with employees to ensure timely completion or complete them ahead of time if employee will be on vacation, out on leave, etc.

For example, FIG. 3b shows at least one embodiment of such as dashboard illustrating information such as that in the hypothetical data structure of FIG. 3a. This is shown on a portion (300) of a user interface device, such as a computer screen, phone display, etc., and should include an indicator of the user or employee name (John Smith), the manager (Bill Adams), and one or more icons associated with incompletion (open box), completion (box with cross or check mark), career goal (circled C), and requirement for current position (circled R). Further, this dashboard may include a timeline depiction, and one or more indicators on the timeline, such as callout boxes, which indicate various deadlines in the user's certification plan.

Exemplary Analytics and Learning Engine Operations.

According to at least one embodiment of the present invention, an analytics engine is utilized to compare the outstanding certification and education requirements to monitor the activity (clicks, frequency, etc.), to provide metrics and analysis to management and employees on status (as applicable), to monitor activity reporting, and to determine and predict why action has not been taken on outstanding items based on information gathered by learning engine on reason for incomplete status and suggest alternatives based on the analysis.

A learning engine is utilized to monitor the activity (or non-activity) taken by users to provide comparisons on activity of user against recommendations based on trends found (i.e. division XY, no one takes class due to cost restrictions so will remove the suggestion from the future profiles), to provide incompletion status reasons (i.e. cost restrictions, lack of time, minimum skill level not met, etc.), to learn what actions were taken on recommendations, to show completion rate and time to completion, and to compare completion status based on user profile categories (i.e. band level, job role, etc.).

### Logical Process Examples

To provide a mechanism for managers to determine the likelihood that their employee would be eligible to participate in a certification program, an example logical process includes tracking a particular criteria measurement of compliance or goal reaching amelioriation index Iₐ:

$$\begin{matrix}{I}_{a} = Percentage of employee acceptance to participate in \\ certification based on a plurality of measurements . \\ = \{ [ ( {e\_cert}_{dept} \text{/} {e\_cert}_{corp} ) + {e}_{caliber} + {I}_{fund} + ROI ] \text{/} 4 \} * 100\end{matrix}$$

where:
e_cert_{dept} represents a number of employees in a department who hold a particular certification (or who fully meet certification requirements);
e_cert_{corp} represents a number of employees in an entire company or organization who hold a particular certification (or who fully meet certification requirements);
e_{caliber} represents a factor as to the caliber of the employees ranging from 0 to 1 with 1 defining an exceptional employee;
I_{fund} is a funding factor ranging from 0 to 1 with 1 identifying a certification program that requires little to no funding; and
ROI is a value ranging from 0 to 1 that identifies the return on investment to the company for employees with the certification, with 1 providing the greatest ROI.

Suitable Computing Platform.

The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

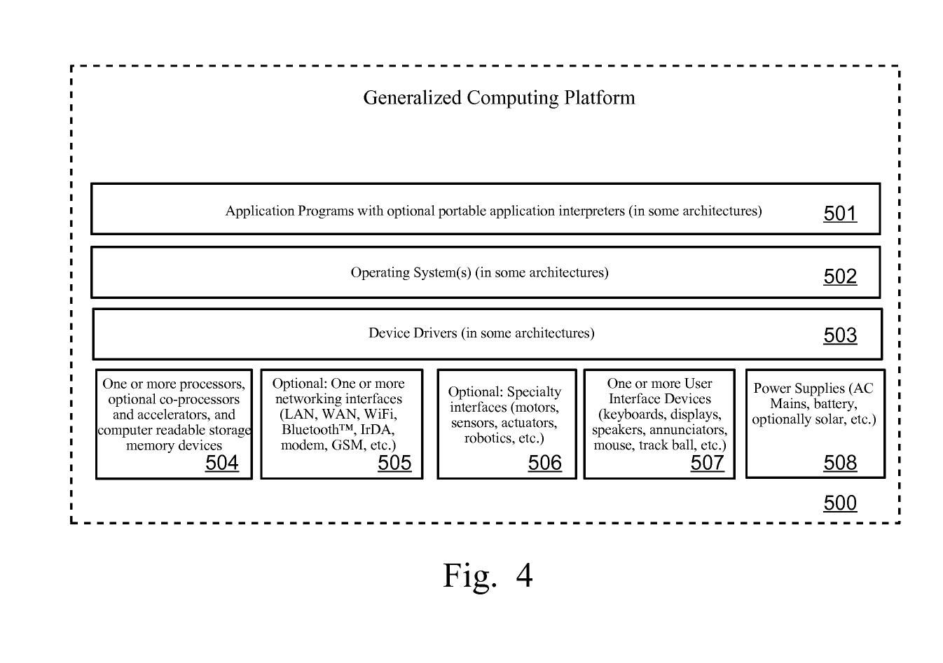

The present invention may be realized for many different processors used in many different computing platforms. FIG. 4 illustrates a generalized computing platform (500), such as common and well-known computing platforms such as “Personal Computers”, web servers such as an IBM iSeries™ server, and portable devices such as personal digital assistants and smart phones, running a popular operating systems (502) such as Microsoft™ Windows™ or IBM™ AIX™, Palm™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method for providing input for business related education and certification comprising:
accessing by a computer a certification requirement, a training requirement, or a combination of certification and training requirements for a first member of a first organization;
applying by a computer an analytical assessment of the requirements against one or more amelioration criteria, wherein the amelioration criteria comprises at least a current training or certification status;
according to the analytical assessment, identifying by a computer one or more employee actions to meet the requirement respective of the amelioration criteria; and
presenting the employee action within a calendar view of a dashboard style display on a user interface device.

2. The method as set forth in claim 1 wherein the employee action is selected from the group consisting of completing a class, attending a presentation, reviewing a document, and obtaining a certification

3. The method as set forth in claim 1 wherein the amelioration criteria is selected from the group consisting of a career goal requirement, a present job role requirement, a required skill, an employment or performance band indicator, a certification requirement, a certification history, a work location indicator, and a reporting structure.

4. The method as set forth in claim 1 wherein the amelioration criteria is selected from the group consisting of a job description, a skill level definition, and a compliance requirement.

5. The method as set forth in claim 1 further comprising:
performing the steps of assessing, applying and identifying for a plurality of members of a first division of the first organization;
performing the steps of assessing, applying and identifying for a plurality of members of the entire first organization; and
calculating and displaying a ratio of members of the first division to members of the entire organization who meet or exceed the amelioration criteria.

6. The method as set forth in claim 1 wherein the steps of assessing, applying and identifying are further performed over members of a second organization.

7. A system for providing input for business related education and certification comprising:
a computer interface for accessing a certification requirement, a training requirement, or a combination of certification and training requirements for a first member of a first organization; and
a processor for applying an analytical assessment of the requirements against one or more amelioration criteria, wherein the amelioration criteria comprises at least a current training or certification status; for, according to the analytical assessment, identifying one or more employee actions to meet the requirement respective of the amelioration criteria; and for presenting the employee action within a calendar view of a dashboard style display on a user interface device.

8. The system as set forth in claim 8 wherein the employee action is selected from the group consisting of completing a class, attending a presentation, reviewing a document, and obtaining a certification

9. The system as set forth in claim 8 wherein the amelioration criteria is selected from the group consisting of a career goal requirement, a present job role requirement, a required skill, an employment or performance band indicator, a certification requirement, a certification history, a work location indicator, and a reporting structure.

10. The system as set forth in claim 8 wherein the amelioration criteria is selected from the group consisting of a job description, a skill level definition, and a compliance requirement.

11. The system as set forth in claim 8 wherein the processor is further for performing the assessing, applying and identifying for a plurality of members of a first division of the first organization; performing the assessing, applying and identifying for a plurality of members of the entire first organization; and for calculating and displaying a ratio of members of the first division to members of the entire first organization who meet or exceed the amelioration criteria.

12. The system as set forth in claim 8 wherein the assessing, applying and identifying are further performed for members of a second or more organization.

13. A computer program product for providing input for business related education and certification comprising:
a tangible, computer-readable storage memory device; and
one or more instructions encoded by the tangible, computer-readable storage memory device for causing a processor to perform the steps of:
accessing by a computer a certification requirement, a training requirement, or a combination of certification and training requirements for a first member of a first organization;
applying by a computer an analytical assessment of the requirements against one or more amelioration criteria, wherein the amelioration criteria comprises at least a current training or certification status;
according to the analytical assessment, identifying by a computer one or more employee actions to meet the requirement respective of the amelioration criteria; and
presenting the employee action within a calendar view of a dashboard style display on a user interface device.

14. The computer program product as set forth in claim 13 wherein the employee action is selected from the group consisting of completing a class, attending a presentation, reviewing a document, and obtaining a certification

15. The computer program product as set forth in claim 13 wherein the amelioration criteria is selected from the group consisting of a career goal requirement, a present job role requirement, a required skill, an employment or performance band indicator, a certification requirement, a certification history, a work location indicator, and a reporting structure.

16. The computer program product as set forth in claim 13 wherein the amelioration criteria is selected from the group consisting of a job description, a skill level definition, and a compliance requirement.

17. The computer program product as set forth in claim 13 wherein the program instructions further comprising instructions for causing a processor to:
perform the steps of assessing, applying and identifying for a plurality of members of a first division of the first organization;
perform the steps of assessing, applying and identifying for a plurality of members of the entire first organization; and
calculate and display a ratio of members of the first division to members of the entire organization who meet or exceed the amelioration criteria.

18. The computer program product as set forth in claim 13 wherein the program instructions for causing assessing, applying and identifying are further for performing these steps over members of a second or more organization.
